(19) United States
(12) Patent Application Publication
(10) Pub. No.: US 2007/0086520 A1
(43) Pub. Date: Apr. 19, 2007

(54) Intra-base-layer prediction method satisfying single loop decoding condition, and video coding method and apparatus using the prediction method

(75) Inventor: So-young Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/546,320

(22) Filed: Oct. 12, 2006

Related U.S. Application Data
(60) Provisional application No. 60/726,216, filed on Oct. 14, 2005.

(30) Foreign Application Priority Data
Feb. 6, 2006 (KR) 10-2006-0011180

(51) Int. Cl. H04B 1/66; H04N 11/02

(52) U.S. Cl. 375/240.1; 375/240.21

(57) ABSTRACT

A method and apparatus for improving the performance of a multi-layer based video codec are provided. The method includes obtaining a difference between a base layer block corresponding to a current layer block and an inter-prediction block for the base layer block; down-sampling an inter-prediction block for the current layer block; adding the difference and the down-sampled inter-prediction block; up-sampling a result of the addition; and encoding a difference between the current layer block and a result of the up-sampling.

### CROSS-REFERENCE TO RELATED APPLICATION

This application claims priority from Korean Patent Application No. 10-2006-0011180 filed on Feb. 6, 2006 in the Korean Intellectual Property Office, and U.S. Provisional Patent Application No. 60/726,216 filed on Oct. 14, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate to video coding, and more particularly, to improving the performance of a multi-layer based video codec.

2. Description of the Prior Art

According to developments in communication technologies including the Internet, in addition to the increase in text and voice communication, image communication is increasing. The related art communication schemes, which are mainly for text communication, cannot satisfy the various demands of customers, so multimedia services capable of providing various types of information including text, image, and music are increasingly being developed. Multimedia data is usually large and requires a large capacity medium for storage and a wide bandwidth for transmission. Therefore, it is important to use a compression coding scheme in order to transmit multimedia data.

The basic principle of data compression is to remove redundancy. Data compression can be achieved by removing spatial redundancy such as repetition of the same color or entity in an image, temporal redundancy such as repetition of the same sound in audio data or little or no change between adjacent pictures in a moving image stream, or the perceptional redundancy based on the fact that the human visual and perceptional capability is insensitive to high frequencies. In typical video coding schemes, temporal redundancy is removed by temporal filtering based on motion compensation, and spatial redundancy is removed by a spatial transform.

Transmission media, which are necessary in order to transmit multimedia data generated, show various levels of performance. Currently used transmission media include media having various transmission speeds, from an ultra high-speed communication network capable of transmitting several tens of mega bits of data per second to a mobile communication network having a transmission speed of 384 kbits per second. In such an environment, it can be said that the scalable vide coding scheme, that is, a scheme for transmitting the multimedia data at a appropriate data rate according to the transmission environment or in order to support transmission media of various speeds, is more appropriate for the multimedia environment.

The scalable video coding is a coding scheme by which it is possible to control a resolution, a frame rate, and a Signal-to-Noise Ratio (SNR) of video by discarding part of a compressed bit stream, that is, a coding scheme supporting various scalabilities.

Currently, the Joint Video Team (JVT), which is a joint working group of the Moving Picture Experts Group (MPEG) and the International Telecommunication Union (ITU), is doing work on standardization, hereinafter, referred to as “H.264 SE” (Scalable Extension), in order to implement scalability in a multi-layer codec based on H.264.

The scalable video codec based on the H.264 SE basically supports four prediction modes including inter-prediction, directional intra-prediction (hereinafter, referred to as simply “intra-prediction”), residual prediction, and intra-base-layer prediction. “Prediction” is a technique for compressively expressing the original data by using prediction data generated from information that is available in both an encoder and a decoder.

Among the four prediction modes, inter-prediction is a mode that is usually used in a video codec having a single layer structure. According to inter-prediction, a block that is most similar to a certain block (current block) of a current picture is searched for from at least one reference picture (previous or future picture), a prediction block that can express the current block as well as possible is obtained from the searched block, and a difference between the current block and the prediction block is quantized.

According to the way of referring to the reference picture, the inter-prediction can be classified into bi-directional prediction which uses two reference pictures, forward prediction which uses a previous reference picture, and a backward prediction which uses a future reference picture.

The intra-prediction is also a prediction scheme used in a single-layer video codec such as H.264. Intra-prediction is a prediction scheme in which a current block is predicted by using pixels adjacent to the current block among the surrounding blocks of the current block. Intra-prediction is different from other prediction modes in that intra-prediction uses only the information within the current picture, and does not refer to other pictures in the same layer or pictures in other layers.

The intra-base-layer prediction can be used in a case where a current picture has a picture (hereinafter, referred to as “base picture”) of a lower layer having the same temporal location in a video codec having a multi-layer structure. As shown in FIG. 2, a macro-block of the current picture can be effectively predicted from the macro-block of the base picture corresponding to the macro-block. Specifically, the difference between the macro-block of the current picture and the macro-block of the base picture is quantized.

When a resolution of a lower layer and a resolution of a current layer are different, the macro-block of the base picture must be up-sampled to the resolution of the current layer before the difference is obtained. When the efficiency of the inter-prediction is not high, for example, in images having very fast motion or images having scene changes, the intra-base-layer prediction described above is especially effective. Intra-base-layer prediction is also called intra-BL prediction.

Finally, inter-prediction with residual prediction (hereinafter, referred to as simply “residual prediction”) is an extension of the inter-prediction from the existing single layer to the multi-layer. As shown in FIG. 3, in the residual prediction, the difference obtained during the inter-prediction of the current layer is not directly quantized, but the obtained difference is compared with a difference obtained through inter-prediction of a lower layer to yield another difference between them, which is then quantized.

In consideration of characteristics of various video sequences, the most effective mode is selected among the four above-mentioned prediction modes, for each of the macro-blocks constituting a picture. For example, the inter-prediction or residual prediction may be selected for video sequences having slow motion, and the intra-base-layer prediction may be mainly selected for video sequences having fast motion.

In comparison with a video codec having a single-layer structure, a video codec having the multi-layer structure has a more complicated prediction structure and mainly uses the open-loop structure. Therefore, more blocking artifacts are observed in the video codec having the multi-layer structure than in the video codec having a single-layer structure. Especially, in the residual prediction, which uses a residual signal of a lower layer picture, a large distortion may occur when the residual signal of the lower layer picture shows characteristics different from those of an inter-predicted signal of the current layer picture.

In contrast, a prediction signal for a macro-block of the current picture during the intra-base-layer prediction, that is, a macro-block of the base picture is not the original signal but is a signal restored after being quantized. Therefore, the prediction signal can be obtained by both an encoder and a decoder, and thus causes no mismatch between the encoder and the decoder. Especially, if the difference between the macro-block of the prediction signal and the macro-block of the current picture is obtained after a smoothing filter is applied to the prediction signal, the blocking artifacts are greatly reduced.

According to the low complexity decoding condition that has been adopted as a working draft of the current H.264 SE, use of the intra-base-layer prediction is limited. That is, according to H.264 SE, use of the intra-base-layer prediction is allowed only when specific conditions are satisfied, so that at least the decoding can be performed in a way similar to the single-layer video codec even if the encoding is performed in the multi-layer manner.

According to the low complexity decoding condition (single loop decoding condition), the intra-base-layer prediction is used only when the macro-block type of a macro-block of a lower layer corresponding to a certain macro-block of the current layer is the intra-prediction mode or the intra-base-layer prediction mode, in order to reduce the operation quantity according to the motion compensation process, which occupies the largest portion of the total operation quantity during decoding. However, such limited use of the intra-base-layer prediction greatly degrades the performance for fast-motion images.

FIG. 1 is a graph illustrating a result obtained by applying a video codec (codec 1) allowing the multi-loop, and a video codec (codec 2) using only the single loop to video sequences having fast motion, e.g. sports sequences, which shows the difference in the luminance component PSNR (Y-PSNR). It should be noted from FIG. 1 that the performance of codec 1 is superior to that of codec 2 for most bit rates.

Although the related art single loop decoding condition can reduce the decoding complexity, it cannot be overlooked that the related art single loop decoding condition also reduces the picture quality. Therefore, it is necessary to develop a method of using the intra-base-layer prediction without restriction while following the single loop decoding condition.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an intra-base-layer prediction method and a video coding method and apparatus which improve the performance of video coding by providing a new intra-base-layer prediction scheme which satisfies the single loop decoding condition in a multi-layer based video codec.

In according with an aspect of the present invention, there is provided a method of multi-layer based video encoding, the method including obtaining a difference between a base layer block corresponding to a current layer block and an inter-prediction block for the base layer block; down-sampling an inter-prediction block for the current layer block; adding the difference and the down-sampled inter-prediction block; up-sampling a result of the addition; and encoding a difference between the current layer block and a result of the up-sampling.

In accordance with another aspect of the present invention, there is provided a method of multi-layer based video decoding, the method including restoring a residual signal of a current layer block from texture data of the current layer block included in an input bit stream; restoring a residual signal of a base layer block from texture data of the base layer block which corresponds to the current layer block and is included in the bit stream; down-sampling an inter-prediction block for the current layer block; adding the down-sampled inter-prediction block and the restored residual signal; up-sampling a result of the addition; and adding the restored residual signal and the result of the up-sampling.

In accordance with another aspect of the present invention, there is provided a multi-layer based video encoder including a subtractor obtaining a difference between a base layer block corresponding to a current layer block and an inter-prediction block for the base layer block; a down-sampler down-sampling an inter-prediction block for the current layer block; an adder adding the difference and the down-sampled inter-prediction block; an up-sampler up-sampling a result of the addition; and an encoding means for encoding a difference between the current layer block and a result of the up-sampling.

In accordance with another aspect of the present invention, there is provided a multi-layer based video decoder including a first restoring means restoring a residual signal of a current layer block from texture data of the current layer block included in an input bit stream; a second restoring means restoring a residual signal of a base layer block from texture data of the base layer block which corresponds to the current layer block and is included in the bit stream; a down-sampler down-sampling an inter-prediction block for the current layer block; a first adder adding the down-sampled inter-prediction block and the residual signal restored by the second restoring means; an up-sampler up-sampling a result of the addition; and a second adder adding the residual signal restored by the first restoring means and the result of the up-sampling.

### BRIEF DESCRIPTION OF THE DRAWINGS

The above and other aspects of the present invention will become apparent from the following detailed description of exemplary embodiments taken in conjunction with the accompanying drawings, in which:

FIG. 1 is a graph illustrating the performance difference between a video codec allowing multi-loop and a video codec using a single loop;

FIG. 2 illustrates an example of application of a de-blocking filter to a vertical boundary between sub-blocks;

FIG. 3 illustrates an example of application of a de-blocking filter to a horizontal boundary between sub-blocks;

FIG. 4 is a flowchart of a process for a modified intra-base-layer prediction process according to an exemplary embodiment of the present invention;

FIG. 5 is a block diagram illustrating a construction of a video encoder according to an exemplary embodiment of the present invention;

FIG. 6 is a view for showing the necessity of padding;

FIG. 7 is a view showing a specific example of padding;

FIG. 8 is a block diagram illustrating a construction of a video decoder according to an exemplary embodiment of the present invention;

FIGS. 9 and 10 are graphs illustrating coding performance of a codec according to the present invention.

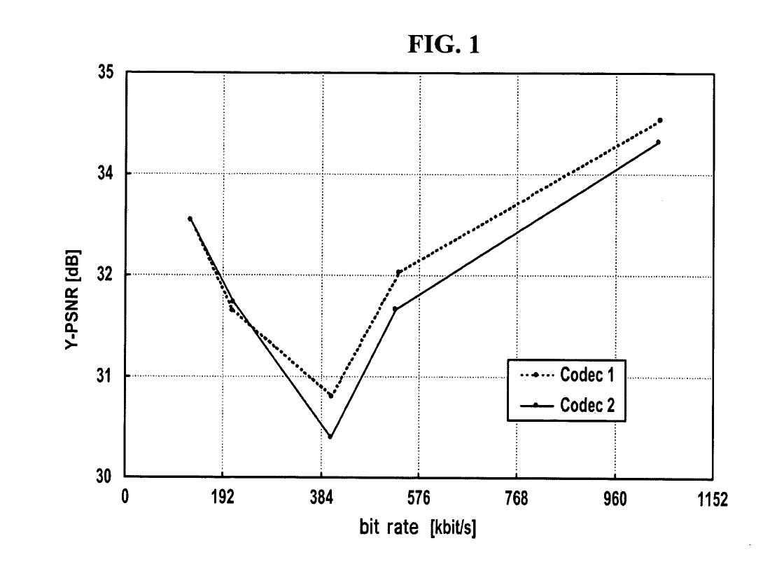

### DETAILED DESCRIPTION OF THE EXEMPLARY EMBODIMENTS

Hereinafter, exemplary embodiments of the present invention will be described with reference to the accompanying drawings. The matters defined in the description such as a detailed construction and elements are provided to assist in a comprehensive understanding of the invention. Thus, it should be apparent that the present invention can be carried out without those defined matters. In the following description of the present invention, the same drawing reference numerals are used for the same elements across different drawings. Also, a detailed description of known functions and configurations incorporated herein will be omitted when it may make the subject matter of the present invention unclear.

As used herein, a layer currently being encoded is called a “current layer,” and another layer to which the current layer makes reference is called a “base layer.” Further, among pictures in the current layer, a picture located at the current time slot for encoding is called a “current picture.”

A residual signal R_{F} obtained by the related art intra-base-layer prediction can be defined by equation (1):
R_{F}=O_{F}−[U]·O_{B} (1)

In equation (1), O_{F} denotes a certain block of the current picture, O_{B} denotes a block of a base layer picture, and U denotes an up-sampled function. Because the up-sampled function is applicable only when the current layer and the lower layer have different resolutions, the up-sampled function is expressed by [U], which implies that it is selectively applicable. However, because O_{B} can be expressed as a sum of a residual signal R_{B} and a prediction signal P_{B} for the block of the base layer picture, equation (1) can be re-expressed as equation (2):
R_{F}=O_{F}−[U]·(P_{B}+R_{B}) (2)

According to the single loop decoding condition, it is impossible to use the intra-base-layer prediction when P_{B} of equation (2) is a signal generated by the inter-prediction. This is a restriction in order to avoid double use of the motion compensation operation which requires a large number of operations during the inter-prediction.

The present invention proposes a new intra-base-layer prediction scheme, which is obtained by slightly modifying the existing intra-base-layer prediction technique as defined by equation (2), and satisfies the single loop decoding condition. According to the proposal of the present invention, the prediction signal P_{B} for the base layer block is obtained by the inter-prediction, the prediction signal is replaced by a prediction signal P_{F} for the current layer block or its down-sampled version.

In relation to this proposal is a document entitled “Smoothed Reference Prediction for Single-loop Decoding,” (hereinafter, referred to as “JVT-0085”) proposed by Woo-Jin Han in the seventeenth JVT meeting (Poznan, Poland) which is incorporated herein by reference. This document also recognizes similar problems and discloses a technical solution for overcoming the restriction of the single loop decoding condition.

According to JVT-0085, R_{F} can be obtained by equation (3):
R_{F}=O_{F}−(P_{F}+[U]·R_{B}) (3)

As noted from equation (3), P_{B} is replaced by P_{F}, and R_{B} is up-sampled in order to match the resolution between layers. Using this method, JVT-0085 also satisfies the single loop decoding condition.

However, JVT-0085 uses up-sampling of the residual signal R_{B} in order to match its resolution with the resolution of the prediction signal P_{F}. However, because the residual signal R_{B} has different characteristics from those of typical images, most samples in the residual signal R_{B} have a sample value of 0, except for some samples having a non-zero value. Therefore, due to the up-sampling of the residual signal R_{B}, JVT-0085 fails to significantly improve the entire coding performance.

The present invention proposes a new approach to down-sample P_{B} of equation (2), and matches its resolution with the resolution of R_{B}. That is, in the proposed new approach, a prediction signal of the base layer used in the intra-base-layer prediction is replaced by a down-sampled version of the prediction signal of the current layer, so as to satisfy the single loop decoding condition.

According to the present invention, it is possible to calculate R_{F} by using equation (4):
R_{F}=O_{F}−[U]·([D]·P_{F}+R_{B}) (4)

When compared with equation (3), equation (4) does not include the process of up-sampling R_{B}, which has the problems as described above. Instead, the prediction signal P_{F} of the current layer is down-sampled, the result thereof is added to R_{B}, and the sum is then up-sampled back to the resolution of the current layer. Because the elements in the parentheses in equation (4) do not represent only a residual signal but represent a signal approaching an actual image, application of up-sampling to the elements does not cause a significant problem.

It is generally known in the art that application of a de-blocking filter in order to reduce the mismatch between a video encoder and a video decoder causes improvement in the coding efficiency.

In the present invention, it is may be preferable to additionally apply a de-blocking filter. When a de-blocking filter is additionally applied, equation (4) is modified to equation (5), wherein B denotes a de-blocking function or de-blocking filter.
R_{F}=O_{F}−[U]·B·([D]·P_{F}+R_{B}) (5)

Both the de-blocking function B and the up-sampling function U have a smoothing effect, so they play an overlapping role. Therefore, it is possible to simply express the de-blocking function B by using linear combination of the pixels located at the block edges and their neighbor pixels, so that the process of applying the de-blocking function can be performed by a small quantity of operation.

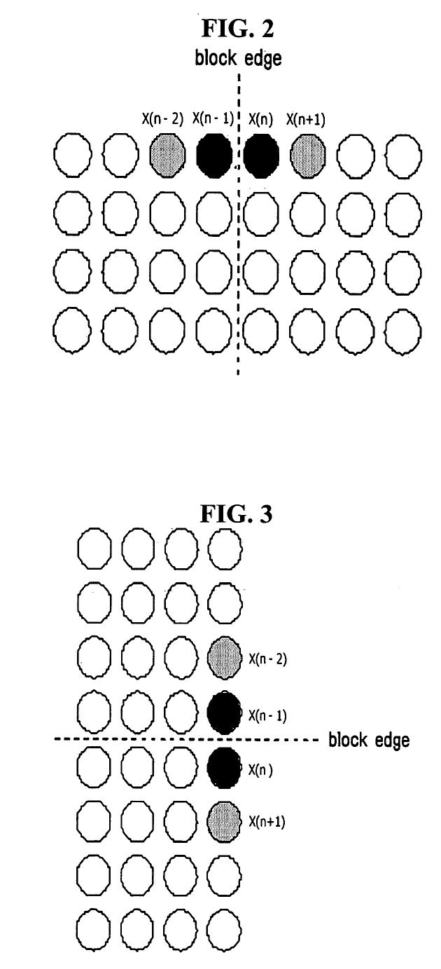

FIGS. 2 and 3 illustrate an example of such a de-blocking filter, when the filter is applied to the vertical edge and the horizontal edge of a 4×4 sized sub-block. As shown in FIGS. 2 and 3, the pixels x(n−1) and x(n), which are located at the edges, can be smoothed through linear combination of themselves with neighbor cells adjacent to them. When the results of the application of the de-blocking filter for the pixels x(n−1) and x(n) are marked as x′(n−1) and x′(n), respectively, x′(n−1) and x′(n) can be defined by equation (6):
x′(n−1)=α*x(n−2)+β*x(n−1)+γ*x(n)
x′(n−1)=γ*x(n−1)+β*x(n)+α*x(n+1) (6)

In equation (6), α, β, and γ may be properly selected so that the sum of them should be 1. For example, by selecting α=¼, β=½, and γ=¼ in equation (6), it is possible to raise the weight of a corresponding pixel to be higher than that of neighbor pixels. Of course, it is possible to select more pixels as neighbor pixels in equation (6).

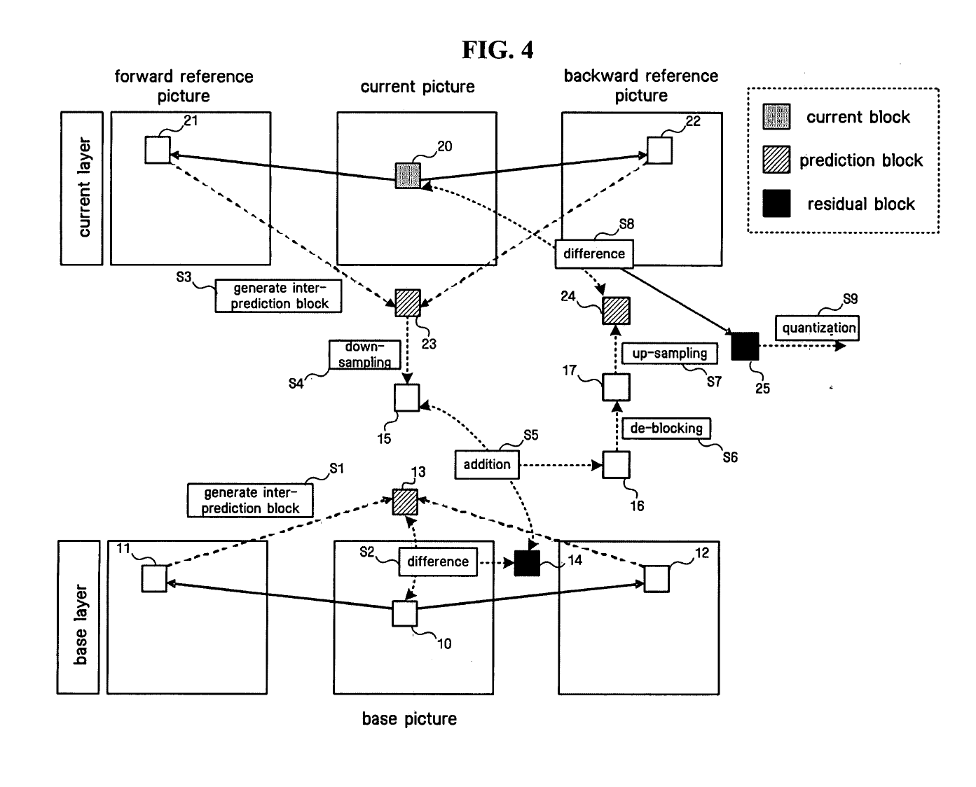

FIG. 4 is a flowchart of a process for a modified intra-base-layer prediction process according to an exemplary embodiment of the present invention.

First, an inter-prediction block 13 for a base block 10 is generated from blocks 11 and 12 in neighbor reference pictures (a forward reference picture and a backward reference picture) of a lower layer corresponding to the base block 10 by motion vectors (S1). Then, a residual 14, which corresponds to R_{B} in equation (5), is obtained by subtracting the prediction block 13 from the base block (S2).

Meanwhile, an inter-prediction block 23 for a current block 20, which corresponds to P_{F} in equation (5), is generated from blocks 21 and 22 in neighbor reference pictures of the current layer, which correspond to the current block 20 by motion vectors (S3). Operation S3 may be performed before operations S1 and S2. In general, the “inter-prediction block” is a prediction block obtained from an image or images of a reference picture corresponding to the current block in a picture to be encoded. The relation between the current block and the corresponding image is expressed by a motion vector. The inter-prediction block may imply either the corresponding image itself when there is a single reference picture or a weighted sum of the corresponding images when there are multiple reference pictures. The inter-prediction block 23 is down-sampled by a predetermined down-sampler (S4). For the down-sampling, an MPEG down-sampler, a wavelet down-sampler, etc. may be used.

Thereafter, the down-sampled result 15, which corresponds to [D]19 P_{F} of equation (5), is added to the residual obtained in operation S2 (S5). Then, the block 16 generated through the addition, which corresponds to [D]·P_{F}+R_{B} in equation (5), is smoothed by using a de-blocking filter (S6). Then, the smoothed result 17 is up-sampled to the resolution of the current layer by using a predetermined up-sampler (S7). For the up-sampling, an MPEG up-sampler, a wavelet up-sampler, etc. may be used.

Then, the up-sampled result 24, which corresponds to [U]·B·([D]·P_{F}+R_{B}) in equation 5, is subtracted from the current block 20 S6. Finally, the residual 25, which is the result of the subtraction, is quantized (S7).

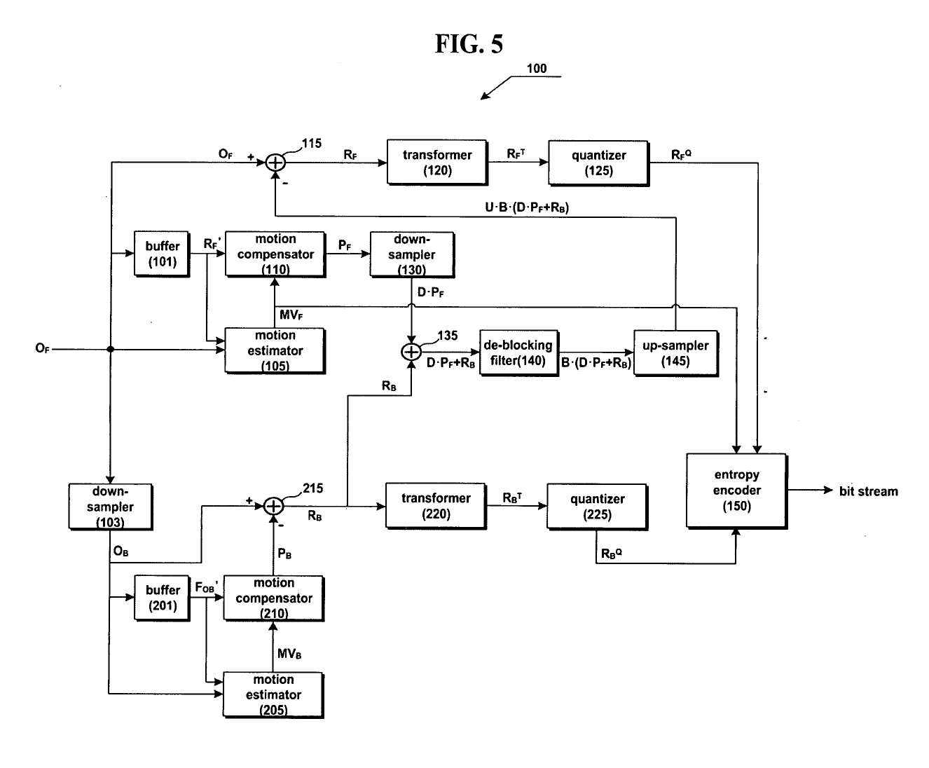

FIG. 5 is a block diagram of a video encoder 100 according to an exemplary embodiment of the present invention.

First, a predetermined block O_{F} (hereinafter, referred to as a “current block”) included in the current picture is input to a down-sampler 103. The down-sampler 103 spatially and/or temporally down-samples the current block O_{F} and generates a corresponding base layer block O_{B}.

The motion estimator 205 obtains a motion vector MV_{B} by performing motion estimation for the base layer block O_{B} with reference to a neighbor picture F_{B}′. Such a referred neighbor picture is called “reference picture.” For the motion estimation, the block matching algorithm is widely used. Specifically, a vector, which has a displacement having a minimum error while a given block is moved pixel by pixel or sub-pixel by sub-pixel ( 2/2 pixel, ¼ pixel, and others) within a particular search area of a reference picture, is selected as the motion vector. For the motion estimation, it is possible to use not only a fixed size block matching but also the Hierarchical Variable Size Block Matching (HVSBM) which has been used in the H.264, and others.

If the video encoder 100 is implemented by an open loop codec, an original neighbor picture F_{OB}′ stored in the buffer 201 will be used as it is for the reference picture. However, if the video encoder 100 is implemented by a closed loop codec, a picture (not shown) which has been decoded after being encoded will be used for the reference picture. The following description is focused on the open loop codec, but the present invention is not limited thereto.

The motion vector MV_{B} obtained by the motion estimator 205 is provided to the motion compensator 210. The motion compensator 210 extracts an image corresponding to the motion vector MV_{B} from the reference picture F_{B}′ and generates an inter-prediction block P_{B} from the extracted image. In the case of using a bi-directional reference, the inter-prediction block can be calculated as an average of the extracted images. In the case of using a unidirectional reference, the inter-prediction block may be the same as the extracted image.

The subtractor 215 generates the residual block R_{B} by subtracting the inter-prediction block P_{B} from the base layer block O_{B}. The generated residual block R_{B} is provided to the adder 135.

In the meantime, the current block O_{F} is input to the motion estimator 105, the buffer 101, and the subtractor 115. The motion estimator 105 calculates a motion vector MV_{F} by performing motion estimation for the current block with reference to the neighbor picture F_{F}′. Such a motion estimation process is the same process as that executed in the motion estimator 205, so repetitive description thereof will be omitted here.

The motion vector MV_{F} by the motion estimator 105 is provided to the motion compensator 110. The motion compensator 110 extracts an image corresponding to the motion vector MV_{F} from the reference picture F_{F}′ and generates an inter-prediction block P_{F} from the extracted image.

Then, the down-sampler 130 down-samples the inter-prediction block P_{F} provided from the motion compensator 110. At this time, the n:1 down-sampling is not a simple process for operating n pixel values into one pixel value but is a process for operating values of neighbor pixels adjacent to n pixels into one pixel value. Of course, the number of neighbor pixels to be considered depends on the down-sampling algorithm. The more the neighbor pixels are considered, the smoother the down-sampling result becomes.

Therefore, as shown in FIG. 6, in order to down-sample an inter-prediction block 31, it is necessary to understand the values of the neighbor pixels 32 adjacent to the block 31. However, although it is possible to obtain the inter-prediction block 31 from reference pictures located at different temporal positions, it is not always possible to obtain the block 33 including the neighbor pixels 32. Especially, this problem emerges when the block 33 including the neighbor pixels 32 belongs to the intra-base mode and the base layer block 34 corresponding to the block 33 belongs to the directional intra-mode. It is because, in actual implementation of the H.264 SE, data of a macro-block is stored in a buffer only when the macro-block of the base layer belongs to the intra-base mode. Therefore, when the base layer block 34 belongs to the directional intra-mode, the base layer block 34 corresponding to the block 33 does not exist in the buffer.

Because the block 33 belongs to the intra-base mode, when there is no corresponding base layer block, it is impossible to generate a prediction block thereof and is thus impossible to completely construct the neighbor pixels 32.

In consideration of such a case as described above, the present invention employs padding in order to generate pixel values of a block including the neighbor pixels, when blocks including the neighbor pixels include no corresponding base layer block.

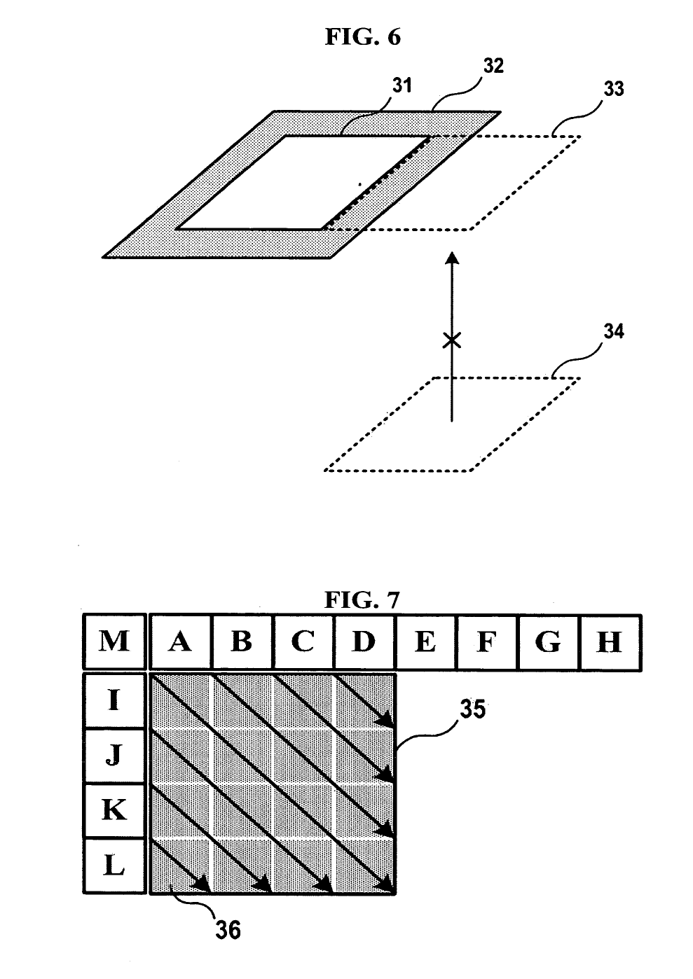

The padding can be performed in a manner similar to the diagonal mode from among the directional intra-prediction, as shown in FIG. 7. That is, pixels I, J, K, and L adjacent to the left side of a certain block 35, pixels A, B, C, and D adjacent to the upper side thereof, and a pixel M adjacent to the left upper corner are copied in a direction with an inclination of 45 degrees. For example, an average of the values of the pixel K and the pixel L is copied to the lowermost-and-leftmost pixel 36 of the block 35.

The down-sampler 130 restores neighbor pixels through the above process when there are omitted neighbor pixels, and then down-samples the inter-prediction block P_{F}.

The adder 135 adds the down-sampled result D·P_{F} and the R_{B} output from the subtractor 215, and provides the result D·P_{F}+R_{B} of the addition to the de-blocking filter 140.

The de-blocking filter 140 smoothes the result D·P_{F}+R_{B} of the addition by applying a de-blocking function thereto. For the de-blocking function forming the de-blocking filter, not only a bi-linear filter may be used as in the H.264, but a simple linear combination can be also used as shown in Equation 6. Further, it is possible to omit such a process by the de-blocking filter, in consideration of the up-sampling process after the de-blocking filter. It is because the smoothing effect can be achieved to some degree only by the up-sampling.

The up-sampler 145 up-samples the smoothed result B·(D·P_{F}+R_{B}), which is then input as a prediction block for the current block O_{F} to the subtractor 115. Then, the subtractor 115 generates the residual signal R_{F} by subtracting the up-sampled result U·B·(D·P_{F}+R_{B}) from the current block O_{F}.

Although it may be preferable to perform the up-sampling after the de-blocking as described above, it is also possible to perform the de-blocking after the up-sampling.

The transformer 120 performs spatial transform for the residual signal R_{F} and generates a transform coefficient R_{F}^{T}. For the spatial transform, various methods including a Discrete Cosine Transform (DCT) and a wavelet transform may be used. The transform coefficient is a DCT coefficient when the DCT is used and is a wavelet coefficient when the wavelet transform is used.

The quantizer 125 quantizes the transform coefficient R_{F}^{T}, thereby generating a quantization coefficient R_{F}^{Q}. The quantization is a process for expressing transform coefficient R_{F}^{T} having a predetermined real number value by using a discrete value. For example, the quantizer 125 may perform the quantization by dividing the transform coefficient R_{F}^{T} expressed as a real number value by predetermined quantization steps and then rounding off the result of the division to a nearest integer value.

Meanwhile, the residual signal R_{B} of the base layer is also transformed to a quantization coefficient R_{B}^{Q} in the same manner by the transformer 220 and the quantizer 225.

The entropy encoder 150 generates a bit stream by performing no-loss encoding for the motion vector MV_{F} estimated by the motion estimator 105, the quantization coefficient R_{F}^{Q} provided by the quantizer 125, and the quantization coefficient R_{B}^{Q} provided by the quantizer 225. For the no-loss encoding, various methods including Huffman coding, arithmetic coding, and variable length coding may be used.

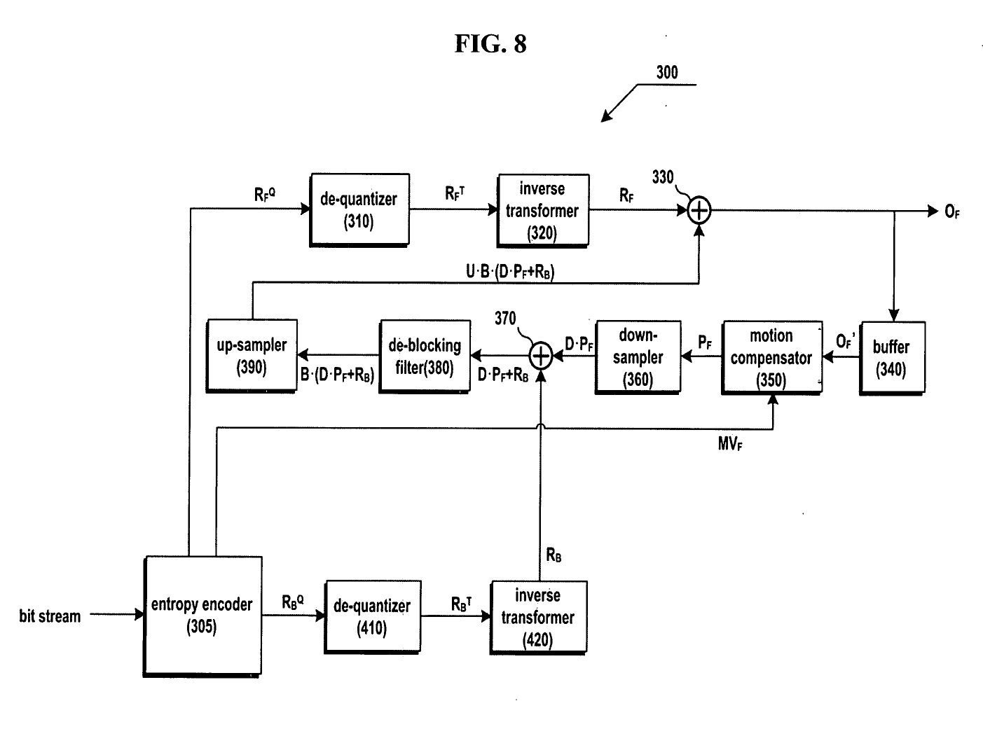

FIG. 8 is a block diagram illustrating a construction of a video decoder 300 according to an exemplary embodiment of the present invention.

The entropy decoder 305 performs no-loss decoding for an input bit stream, so as to extract texture data R_{F}^{Q} of a current block, texture data R_{B}^{Q} of a base layer block corresponding to the current block, and a motion vector MV_{F} of the current block. The no-loss decoding is an inverse process to the no-loss encoding.

The texture data R_{B}^{Q} of the base layer block is provided to the de-quantizer 410 and the texture data R_{F}^{Q} of the current block is provided to the de-quantizer 310. Further, the motion vector MV_{F} of the current block is provided to the motion compensator 350.

The de-quantizer 310 de-quantizes the received texture data R_{F}^{Q} of the current block. The de-quantization is a process of restoring a value matching with an index, which is generated during quantization, by using the same quantization table as that used during the quantization process.

The inverse transformer 320 performs an inverse transform for the result of the de-quantization. Such an inverse transform is a process inverse to the transform at the encoder side, which may include an inverse DCT, an inverse wavelet transform, and others.

As a result of the inverse transform, the residual signal R_{F} for the current block is restored.

In the meantime, the de-quantizer 410 de-quantizes the received texture data R_{B}^{Q} of the base layer block, and the inverse transformer 420 performs an inverse transform for the result R_{B}^{T} of the de-quantization. As a result of the inverse transform, the residual signal R_{B} for the base layer block is restored. The restored residual signal R_{B} is provided to the adder 370.

The buffer 340 temporarily stores the finally restored picture and then provides the stored picture as a reference picture at the time of restoring another picture.

The motion compensator 350 extracts a corresponding image O_{F}′ indicated by the motion vector MV_{F} among reference pictures, and generates an inter-prediction block P_{F} by using the extracted image. When the bi-directional reference is used, the inter-prediction block P_{F} can be calculated as an average of the extracted images O_{F}′. In contrast, when the uni-directional reference is used, the inter-prediction block P_{F} may be the same as the extracted image O_{F}′.

The down-sampler 360 down-samples the inter-prediction block P_{F} provided from the motion compensator 350. The down-sampling process may include the padding as shown in FIG. 7.

The adder 370 adds the down-sampled result D·P_{F} and the residual signal R_{B} provided from the inverse transformer 420.

The de-blocking filter 380 smoothes the output D·P_{F}+R_{B} of the adder 370 by applying a de-blocking function thereto. For the de-blocking function forming the de-blocking filter, not only a bi-linear filter may be used as in the H.264, but a simple linear combination can be also used as shown in Equation 6. Further, it is possible to omit such a process by the de-blocking filter, in consideration of the up-sampling process after the de-blocking filter.

The up-sampler 390 up-samples the smoothed result B·(D·P_{F}+R_{B}), which is then input as a prediction block for the current block O_{F} to the adder 330. Then, the adder 330 adds the residual signal R_{F} and the up-sampled result U·B·(D·P_{F}+R_{B}), thereby restoring the current block O_{F}.

Although it may be preferable to perform the up-sampling after the de-blocking as described above, it is also possible to perform the de-blocking after the up-sampling.

Although an example of coding of a video frame having two layers has been described above with reference to FIGS. 5 and 8, it is apparent to those skilled in the art that the present invention is not limited to such an example and is applicable to coding of a video frame having a structure of more than two layers.

Each of the elements described above with reference to FIGS. 5 and 8 may be implemented by software executed at a predetermined region in a memory, such as task, class, sub-routine, process, object, execution thread, or program, hardware, such as a Field-Programmable Gate Array (FPGA) or an Application-Specific Integrated Circuit (ASIC), or a combination of such software and hardware. These elements may be included in a storage medium readable by a computer or distributed to multiple computers.

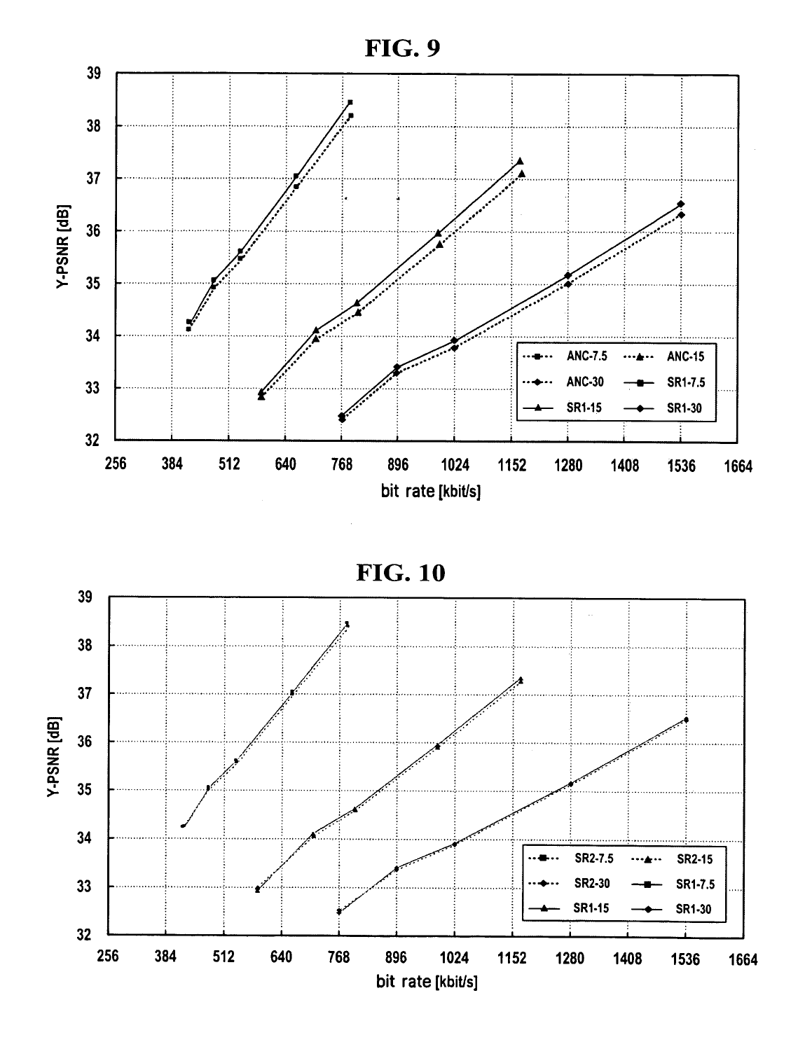

FIGS. 9 and 10 are graphs for illustrating coding performance of a codec SR1 according to the present invention. FIG. 9 is a graph for showing comparison of luminance PSNR (Y-PSNR) between the inventive codec SR1 and the related art codec ANC in video sequences having various frame rates of 7.5, 15, and 30 Hz. As shown FIG. 9, the codec according to the present invention shows an improvement of maximum 25 dB in comparison with the related art codec, and such a PSNR difference is observed nearly constant regardless of the frame rates.

FIG. 10 is a graph showing a comparison of the performance of a codec SR2 to which a method presented by the JVT-85 document is applied and the performance of the inventive codec SR1 in video sequences having various frame rates. As noted from FIG. 10, the PSNR difference between the two codec is maximum 0.07 dB, which is maintained during most comparison intervals.

According to the present invention, it is possible to use the intra-base-layer prediction without limitation, while satisfying the single loop decoding condition in a multi-layer based video codec.

Such unlimited use of the intra-base-layer prediction can improve the performance of the video coding.

Although exemplary embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A method of multi-layer based video encoding, the method comprising:
obtaining a difference between a base layer block corresponding to a current layer block and an inter-prediction block for the base layer block;
down-sampling an inter-prediction block for the current layer block;
adding the difference and the down-sampled inter-prediction block;
up-sampling a result of the adding; and
encoding a difference between the current layer block and a result of the up-sampling.

2. The method of claim 1, further comprising a de-block filtering the result of the adding, wherein the result of the up-sampling is a result of the de-blocking filtering.

3. The method of claim 2, wherein a de-blocking function used in the de-blocking filtering is expressed as linear combination of a pixel located at an edge of the current layer block and neighbor pixels of the current layer block.

4. The method of claim 3, wherein the neighbor pixels include two pixels located adjacent to the pixel located at the edge, which has a weight of ½, and each of the two neighbor pixels has a weight of ¼.

5. The method of claim 1, wherein the inter-prediction block for the base layer block and the inter-prediction block for the current layer block are generated through motion estimation and motion compensation.

6. The method of claim 1, wherein the encoding the difference between the current layer block and the result of the up-sampling comprises:
performing spatial transform for the difference between the current layer block and the result of the up-sampling to generate a transform coefficient;
quantizing the transform coefficient to generate a quantization coefficient; and
performing no-loss encoding for the quantization coefficient.

7. The method of claim 1, wherein the down-sampling the inter-prediction block for the current layer block comprises padding a neighbor prediction block adjacent to the inter-prediction block if a base layer block corresponding to the neighbor prediction block does not exist in a buffer.

8. The method of claim 7, wherein, in the padding, pixels adjacent to a left side and an upper side of the neighbor prediction block are copied to the neighbor prediction block in a direction with an inclination of 45 degrees.

9. A method of multi-layer based video decoding, the method comprising:
restoring a residual signal of a current layer block from texture data of the current layer block included in an input bit stream;
restoring a residual signal of a base layer block from texture data of the base layer block which corresponds to the current layer block and is included in the bit stream;
down-sampling an inter-prediction block for the current layer block;
adding the down-sampled inter-prediction block and the restored residual signal;
up-sampling a result of the adding the down-sampled inter-prediction block and the restored residual signal; and
adding the restored residual signal and a result of the up-sampling.

10. The method of claim 9, further comprising de-block filtering the result of the adding the down-sampled inter-prediction block and the restored residual signal, wherein the result of the up-sampling is a result of the de-block filtering.

11. The method of claim 10, wherein a de-blocking function used in the de-block filtering is expressed as linear combination of a pixel located at an edge of the current layer block and neighbor pixels of the current layer block.

12. The method of claim 11, wherein the neighbor pixels include two pixels adjacent to the pixel located at the edge, which has a weight of ½, and each of the two neighbor pixels has a weight of ¼.

13. The method of claim 9, wherein the inter-prediction block for the current layer block is generated through motion compensation.

14. The method of claim 9, wherein the restoring the residual signal of the current layer block comprises:
performing no-loss decoding for the texture data;
de-quantizing a result of the no-loss decoding; and
performing inverse transform for a result of the de-quantizing.

15. The method of claim 9, wherein the down-sampling the inter-prediction block for the current layer block comprises padding a neighbor prediction block adjacent to the inter-prediction block when a base layer block corresponding to the neighbor prediction block does not exist in a buffer.

16. The method of claim 15, wherein, in the padding, pixels adjacent to a left side and an upper side of the neighbor prediction block are copied to the neighbor prediction block in a direction with an inclination of 45 degrees.

17. A multi-layer based video encoder comprising:
a subtractor which obtains a difference between a base layer block corresponding to a current layer block and an inter-prediction block for the base layer block;
a down-sampler which down-samples an inter-prediction block for the current layer block;
an adder which adds the difference and the down-sampled inter-prediction block;
an up-sampler which up-samples a result of the addition by the adder; and
encoding means for encoding a difference between the current layer block and a result of the up-sampling by the up-sampler.

18. A multi-layer based video decoder comprising:
first restoring means for restoring a residual signal of a current layer block from texture data of the current layer block included in an input bit stream;
second restoring means for restoring a residual signal of a base layer block from texture data of the base layer block which corresponds to the current layer block and is included in the bit stream;
a down-sampler which down-samples an inter-prediction block for the current layer block;
a first adder which adds the down-sampled inter-prediction block and the residual signal restored by the second restoring means;
an up-sampler which up-samples a result of the addition by the first adder; and
a second adder which adds the residual signal restored by the first restoring means and a result of the up-sampling by the up-sampler.
